(19) United States
(12) Patent Application Publication
(10) Pub. No.: US 2012/0190439 A1
(43) Pub. Date: Jul. 26, 2012

(54) MULTIPLE SIMULTANEOUS PROGRAMS ON A DISPLAY

(75) Inventor: Farhad Nourbakhsh, Apple Valley, MN (US)

(73) Assignee: BBY SOLUTIONS, INC., Richfield, MN (US)

(21) Appl. No.: 13/193,027

(22) Filed: Jul. 28, 2011

Related U.S. Application Data
(60) Provisional application No. 61/370,200, filed on Aug. 3, 2010.

(51) Int. Cl. A63F 13/12; H04N 13/04

(52) U.S. Cl. 463/31; 348/54; 348/56; 348/E13.059

(57) ABSTRACT

A system and method is presented for enabling the viewing of multiple, different programs simultaneously on a single television display. The system can use alternate frame sequencing to alternate the programs frame-by-frame. A first pair of shutter glasses received a synchronization signal from the television and controls both the left and right glass in tandem to view the first program, while a second pair operates similarly, but uses the same synchronization signal to view the second program. Alternatively, the system can use polarization, in which a first program is polarized in a first orientation while a second program is polarized in a second orientation. Polarized glasses with matching orientations allow the user to watch only a single program.

### CROSS REFERENCE TO RELATED APPLICATION

This application claims the benefit of U.S. Provisional Application No. 61/370,200, filed Aug. 3, 2010, which is hereby incorporated by reference.

### FIELD OF THE INVENTION

The present application relates to the field of television display devices. More particularly, the described embodiments relate to the viewing of a plurality of different programs simultaneously on a single television display.

### BRIEF DESCRIPTION OF THE DRAWINGS

FIG. 1 is a schematic diagram showing one embodiment of the present invention displaying a single 3-D image.

FIG. 2 is a timeline showing the presentation of images in the embodiment of FIG. 1.

FIG. 3 is a schematic diagram showing another embodiment of the present invention displaying two 2-D images.

FIG. 4 is a timeline showing the presentation of frames in the embodiment of FIG. 3.

FIG. 5 is a schematic diagram of the shutter glasses from FIG. 3 being used in conjunction with associated headphones.

FIG. 6 is a schematic diagram showing another embodiment of the present invention displaying two 3-D images.

FIG. 7 is a timeline showing the presentation of images in the embodiment of FIG. 6.

FIG. 8 is a schematic diagram showing another embodiment of the present invention displaying four 2-D images.

FIG. 9 is a timeline showing the presentation of frames in the embodiment of FIG. 8.

FIG. 10 is a schematic diagram showing another embodiment of the present invention displaying two programs to position-sensitive shutter glasses.

FIG. 11 is a schematic diagram showing the major components of one embodiment of the shutter glasses.

FIG. 12 is a schematic diagram showing the major components of one embodiment of the headset.

FIG. 13 is a schematic diagram showing the major components of one embodiment of the television.

FIG. 14 is a schematic diagram showing the major components of another embodiment of the present invention utilizing a home theater receiver.

FIG. 15 is a schematic diagram showing the major components of one embodiment of a gaming system.

FIG. 16 is a flow chart for the operation of a television.

FIG. 17 is a flow chart for the operation of shutter glasses.

FIG. 18 is a schematic diagram showing another embodiment of the present invention displaying two programs to passive, polarization-based glasses.

### DETAILED DESCRIPTION

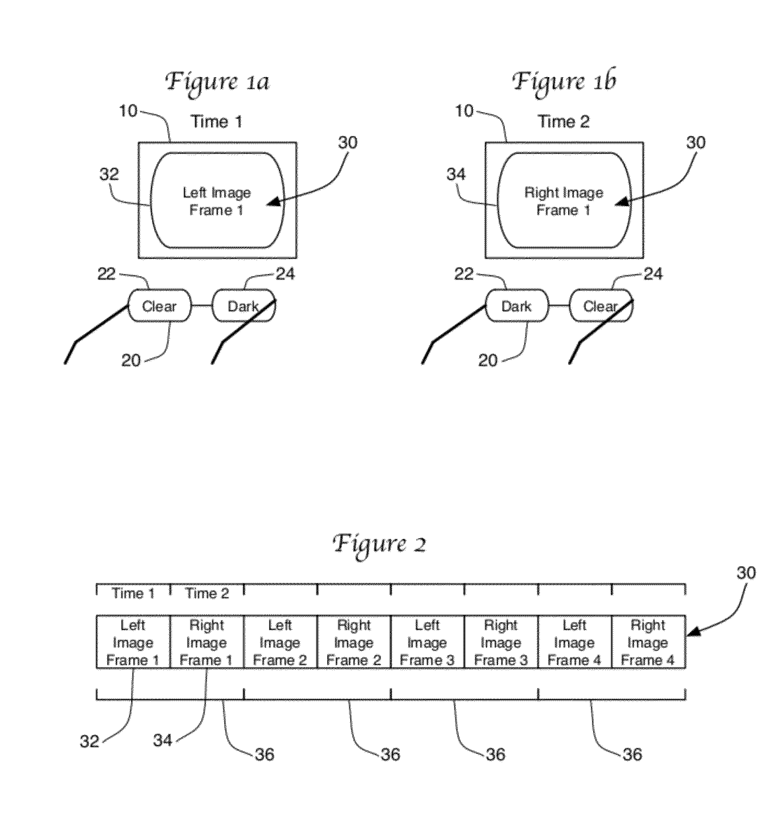

FIGS. 1a and 1b each show a television 10 that is being viewed by a set of shutter glasses 20 at two different times, with FIG. 1a showing “time 1” and FIG. 1b showing “time 2.” The television 10 may be incorporate a tuning device, or may take the form of a video monitor having no tuner. The program 30 being displayed on television 10 is designed to be viewed in three-dimensions (3-D). At time 1, television 10 is showing is showing an image 32 destined for the left eye. In particular, the image 32 shown by television 10 comprises the left image from frame one of television program 30. In order to ensure that this image 32 is seen by the viewers left eye, the left eye glass 22 of shutter glasses 20 is clear during time 1, while the right eye glass 24 of the shutter glasses 20 is kept dark. The darkness of the right eye glass 24 prevents the right eye of the user of glasses 20 from seeing image 32. At time 2, the television 10 is showing image 34 of program 30. This image 34 comprises the right image of the same frame one of the program 30. During time 2, the shutter glasses 20 ensure that the left glass 22 is dark while the right glass 24 is clear, thereby allowing only the right eye of the user to see image 34. As shown in FIG. 2, the left and right images 32, 34 of frame one are followed sequentially by the left and right images of frames two through four. In this manner, the display of program 30 alternates between the left and right images for each frame of the program. This technique is referred to as alternate-image sequencing (or alternate-frame sequencing).

The shutter glasses 20 can be of any configuration designed to synchronize with television 10. In one embodiment, the glasses 20 are liquid crystal (or “LC”) shutter glasses. In LC shutter glasses 20, each glass 22, 24 contains an LC layer that is transparent when no voltage is applied to the layer, and becomes dark when voltage is applied. The glasses 20 are controlled by a timing or synchronization signal sent from the television 10 that informs the glasses 20 when to darken the left glass 32 and right glass 34. This timing signal, which might be optical (i.e., infrared) or radio frequency (i.e., Bluetooth), is received by a receiver embedded into the glasses 20. By changing the transparency of the left and right glass 22, 24 in synchronization with the television 10, the user will see the left image 32 with their left eye and the right image 34 with their right eye, and merge the two images into a single 3-D program.

The television 10 can use LCD, CRT, or plasma display panel technology. Alternatively, the television 10 can be constructed as a projection device that might use DLP, LCD, or LCoS projection technology. A projection television could be configured as a front or rear projection system, with some rear projection systems being configured so that the projector and the display screen are contained within the same unit.

The alternate-image sequencing technique for presenting three-dimensional programming requires that the television 10 have a sufficiently high frame or image rate. Modern LCD televisions are capable of showing 120 or 240 frames per second, which is also referred to as a 120 or 240 Hz refresh rate. In some cases, LCD television frame rates are exaggerated in that the rates do not sufficiently account for the LCD response time required for each LCD pixel to transition between states. Assuming the television 10 has a true 120 image per second refresh rate, each frame 36 in the programming 30 (consisting of both a left and right image 32, 34) is refreshed every 60 seconds, which is sufficient to provide a quality viewing experience for users. Plasma and projection televisions with similar or higher refresh rates can also provide a quality 3-D viewing experience.

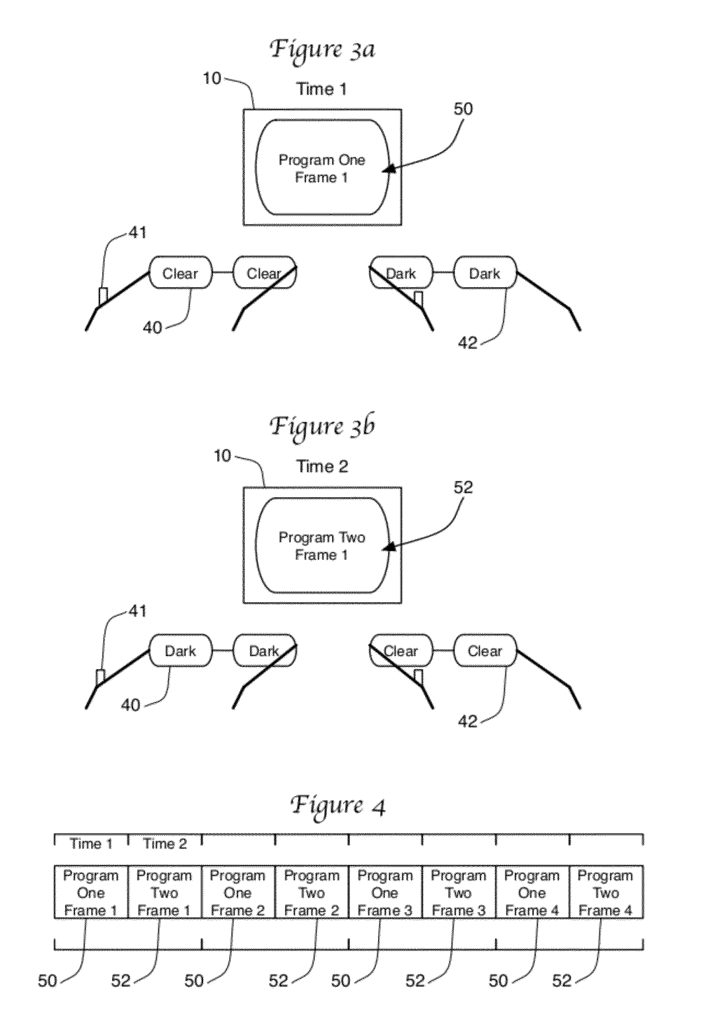

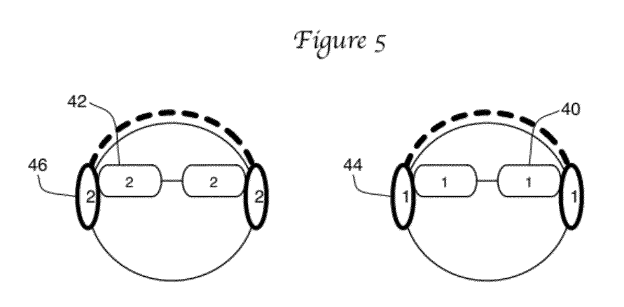

FIGS. 3a and 3b show the simultaneous display of two distinct programs 50, 52 on the same television 10 using at least two pairs of shutter glasses 40, 42. FIG. 3a shows the display of a first frame of program one 50 at time 1, while FIG. 3b shows the display of a first frame of program two 52 at time two. As shown in the timeline of FIG. 4, the two programs 50, 52 are alternated frame by frame by the television 10. Starting with frame one of program one 50 at time 1, the television then shows the first frame of program two 52 at time 2. The next frame shown is the second frame of program one 50, then the second frame of program two 52, and so on alternating between frames of the two programs 50, 52. Because two programs 50, 52 are being displayed simultaneously, the effectively frame rate for each program will be half of the actual refresh rate for the television 10, as was the case in the 3-D display described in FIGS. 1-2.

In the embodiment shown in FIGS. 3 and 4, the shutter glasses 40, 42 are programmed to display program one 50, and program two 52 respectively. When program one is displayed at time 1, a synchronization signal from the television 10 causes the first set of shutter glasses 40 to have both eyes clear while simultaneously causing the second set of shutter glasses 42 to have both eyes dark. The synchronization signal can take the same form as the optical or radio frequency signal that was used to create a 3-D image as described above in connection with FIGS. 1-2.

In one embodiment, the glasses 20, 40, 42 and the television 10 can easily switch between the 3D mode shown in FIGS. 1 and 2, and the two-program, 2D mode shown in FIGS. 3 and 4. Changes between modes can be communicated between the glasses 20, 40, 42 and the television 10, so that a user may communicate their desire to change modes on one device (i.e., on the television 10, the glasses 20, 40, 42, or a remote control, not shown), and have that change understood by all of the effected devices.

In FIG. 3b, program two 52 is displayed on television 10 at time 2. The synchronization signal sent by the television at this time causes both eyes of the first pair of glasses 40 to be dark and both eyes of the second pair of glasses 42 to be clear. As the television 10 alternates between frames of program one 50 and program two 52 as shown in the timeline of FIG. 4, the synchronization signal alternates between allowing glasses 40 and 42 in viewing the program. In this matter, the users that are wearing the first and second pair of glasses 40, 42 can separately watch programs one 50 and program two 52 on the same television 10. The programs 50, 52 may be television shows, movies, or sports, thereby allowing, for example, one user to watch a live presentation of a sporting event while another user watches a dramatic movie.

In a preferred embodiment, the television emits only a single timing or synchronization signal that is treated differently by the two glasses 40, 42 so as to be synched to the different programs 50, 52. Although a single timing signal is preferred, it would be within the scope of the present invention to have separate signals to control the two different glasses 40, 42. When a single signal is used, the glasses 40, 42 could be identically constructed with a physical switch (element 41) that allows the user of the glasses 20, 21 to select to watch either program one 50 or program two 52. When set in a first position, the switch 41 causes the glasses 40 to watch a first program 50. In the second position, the switch 41 would cause the glasses 40 to watch the second program 52.

Because each program 50, 52 has both a video and an audio component, it is desired that the user of each pair of shutter glasses 40, 42 also have access to the audio portion of the program 50, 52 that they are currently viewing. In another embodiment, this is accomplished through the use of audio headsets 44, 46. As shown in FIG. 5, the two users of the glasses 40, 42 are each wearing an audio headset 44, 46 in order to hear the audio portion of their selected program. As shown by the numbers on the ear cups of the headsets 44, 46 and the eye-glass of the shutter glasses 40, 42, the audio and video components of the programs 50, 52 coincide. To ensure this result, the selection made by the switch 41 on the glasses 40, 42 must communicate its setting to the audio headset 44, 46 worn by the user. This can be communicated through a wireless data communication (such as a digital Bluetooth link) between the headsets 44, 46 and the glasses 40, 42. Alternatively, a wired link may be established. Whatever the means of communication, the glasses 40, 42 can communicate the selection made by the user. The television 10 simultaneously transmits both audio portions simultaneously over separate channels. The television 10 can transmit these audio signals through internal circuitry, or through the use of an external audio amplifier such as a specially designed home theater receiver. The headsets 44, 46 then select the correct channel and present the audio to the user so as to complete the presentation of the programs 50, 52. Alternatively, the glasses 40, 42 can each include a wireless receiver to receive the separate audio channels from the television 10. The glasses can then select the correct channel to correspond to the selected video, and then provide the appropriate audio signal to the headset 44, 46 through either a wireless or wired connection.

In yet another embodiment, the shutter glasses 40, 42 contain a receiver to receive and decode the appropriate audio channel, and then present the decoded audio channel to the headset 44, 46 through a standard audio plug located on the shutter glasses 40, 42. While this configuration adds weight and complexity to the shutter glasses 40, 42, it does allow the glasses 40, 42 to be used with any standard audio headset 44, 46.

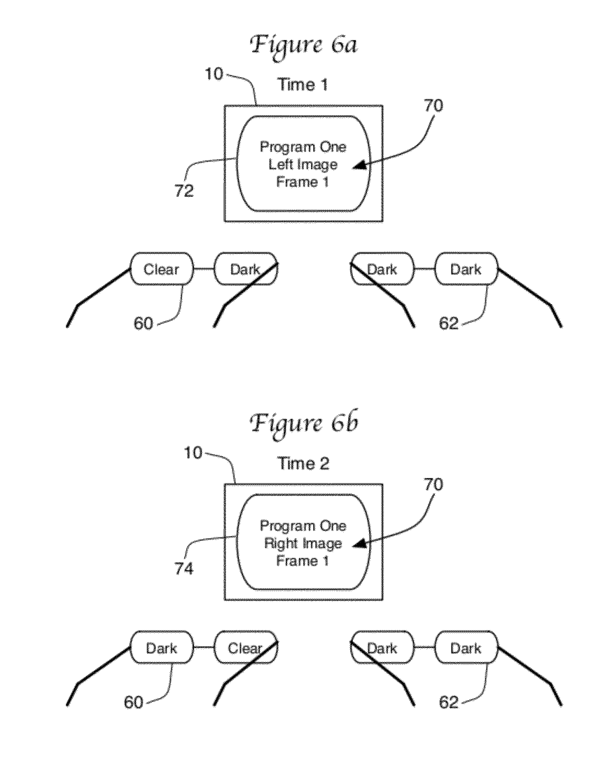

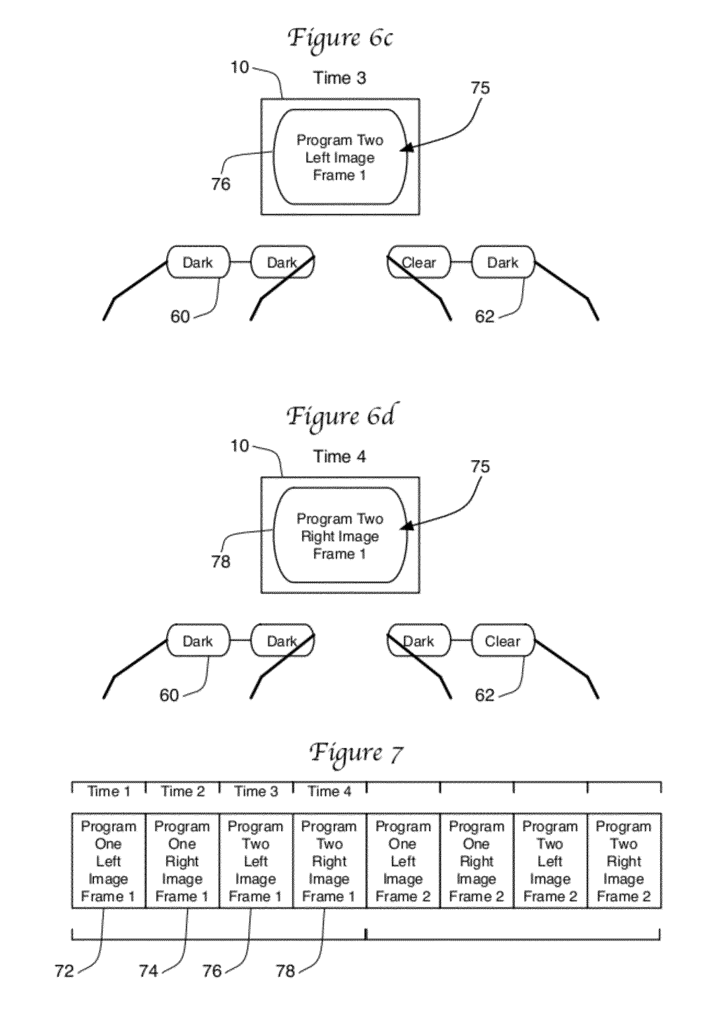

In FIGS. 6a-6d, television 10 is shown providing two simultaneous 3-D programs 70, 75 to two separate pairs of shutter glasses 60, 62. At time 1 in FIG. 6a, the left image of frame one of program one 70 is presented to the left-eye glass of pair 60. The right-eye glass of pair 60 and both eyes of pair 62 remain dark. At time 2, the right image of frame one of program one is presented only to the right-eye glass of glasses pair 60, as shown in FIG. 6b. Similarly, FIGS. 6c and 6d show the left image 76 and right image 78 for frame 1 of program two 75 being presented to the left-eye and right-eye glass of frames 62, respectively.

In order to present two different 3-D images, the left and right eye images for each of the programs 70, 75 must be presented sequentially, as shown in FIG. 7. The frames per second for the television 10 must be sufficiently high in order to present both the left and right image for each user at a tolerable frequency. While it may be possible to present full frames 30 times per second, it is preferred to present 60 fps. With four images required for each frame (left and right images for program one 70 and program two), this would require a television to produce 240 frames per second.

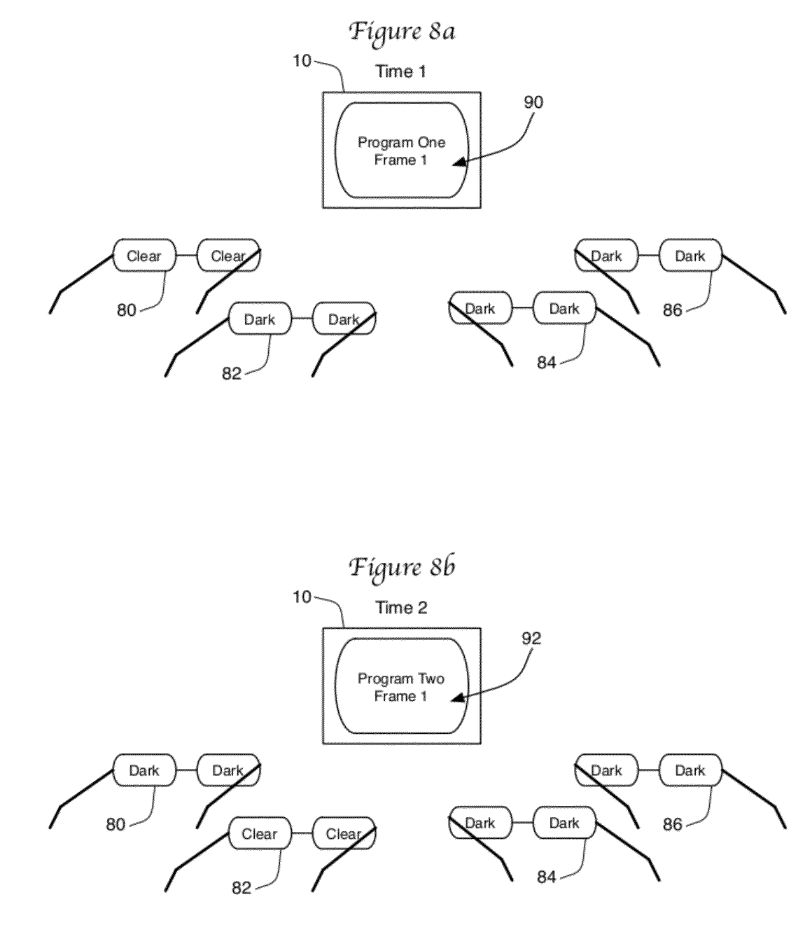

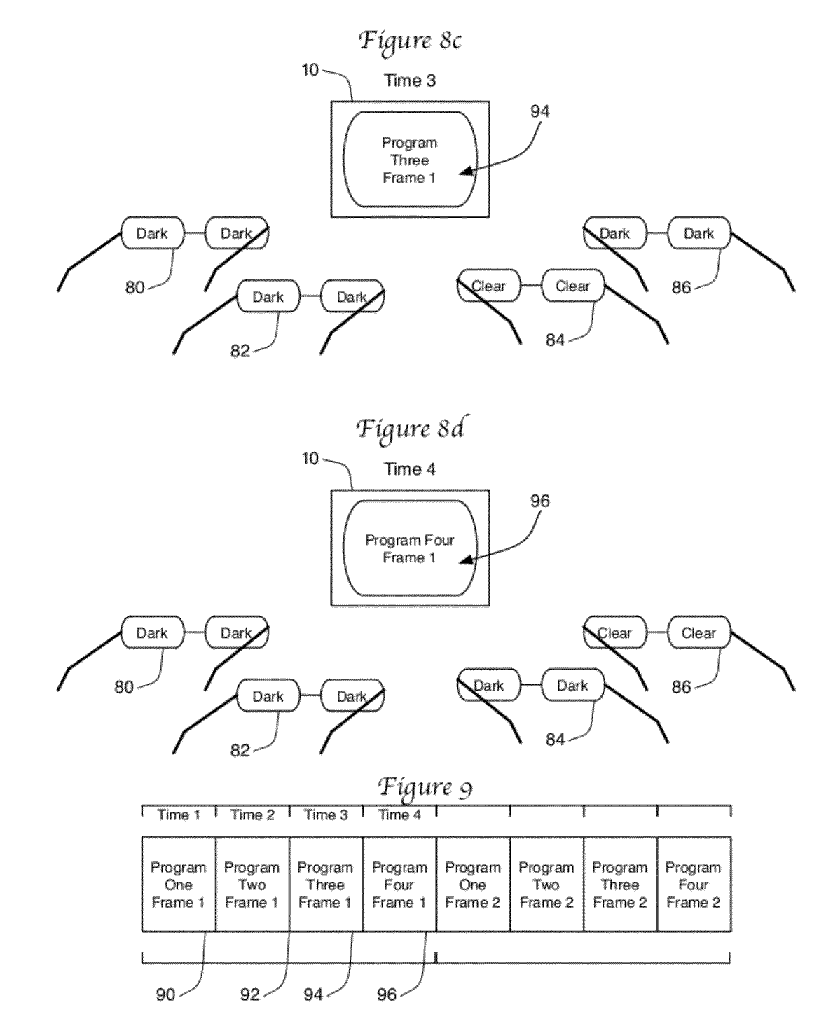

FIGS. 8a-8d show an embodiment where four simultaneous programs 90-96 are being displayed on the same television 10. FIGS. 8a-8d show the television 10 and four pairs of shutter glasses 80-86 at four different times. In FIG. 8a (time 1), a frame from program one 90 is being displayed, while only the first pair of glasses 80 has clear glass with the other glasses 82-86 blocking vision of program one 90 by darkening their lenses. At time 2 (FIG. 8b), program two 92 is being displayed with only glasses 82 allowing a view of the image on television 10. At time 3 (FIG. 8c), program three 94 is displayed and viewable only on glasses 84, while at time 4 (FIG. 8d) program four 96 is made visible to only glasses 86.

As shown in the timeline in FIG. 9, frames from the four programs 90-96 are alternated so as to allow four separate programs to be viewed simultaneously by four different individuals on the same television 10. As shown in this timeline, the effective frame rate of the television 10 for each viewer will be one-fourth of the television's actual frame rate. To present 60 frames per second to each of the four users, the television 10 must produce a total of 240 images per second.

One disadvantage of splitting the television signal between two or four images as done in the above examples is that each viewer is seeing the television for only one-half or one-fourth of the total time. As a result, the amount of light reaching the viewer will also be cut to one-half or one-fourth of the output of the television. One way to compensate for this effect is to increase the overall brightness of the television. In addition, users viewing the television in a darkened room will be less likely to notice the decreased brightness of the image.

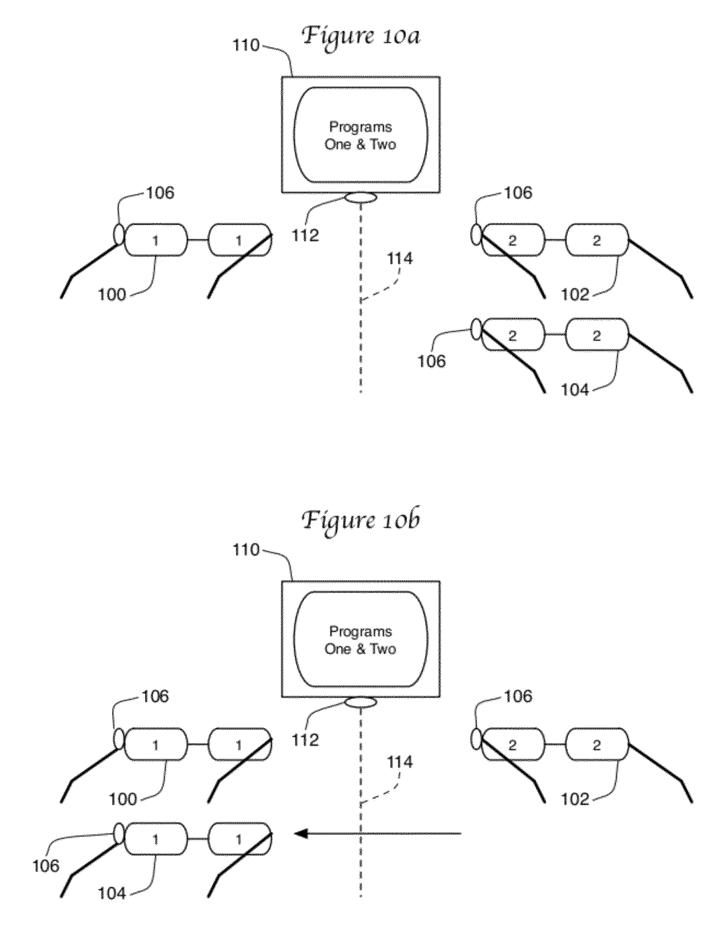

In FIGS. 10a and 10b, shutter glasses 100-104 are shown in use with a television 110 that has a position indicator device 112. The position indicator device 112 helps to identify the location of the television 110 to the shutter glasses 100-104. Each of the shutter glasses 100-104 is designed with a cooperative location device 106 that interacts with the location indicator device 112 associated with the television 110. These two devices 106, 112 cooperate to inform the shutter glasses 100-104 of their location relative to the television 110. By knowing this location information, the shutter glasses 100-104 are able to synchronize with the various programs being displayed on the television 110 according to the location of the user. For example, the television 110 may show both program one and two using the technique described above in connection with FIGS. 3 and 4. In FIG. 10a, shutter glasses 100 are located to the left of the center of television 110 (indicated as center line 114), and therefore are synchronized to view program one. In contrast, shutter glasses 102 and 104 are located to the right of the center of television 110, and therefore are synchronized to view program two. With the use of the sensor 108 on the glasses, the user of glasses 106 can switch from program two to program one merely by repositioning themselves to the left of the center line 114, as shown in FIG. 10b.

In one embodiment, the position indicator device 112 may comprise one or more optical sources on the television 110 that can be viewed by optical receivers in the cooperative location device 106. By properly locating the light sources that comprise indicator device 112, it is possible for the sensors that comprise the cooperative location device 106 to determine its location with respect to the center line 114 of the television. For example, the light sources can be positioned on or near the television 110 in an arcuate pattern that intersects the center line 114 at approximately ninety degrees. Variations in the perceived distance between the light sources when viewed by the sensors 106 can then be interpreted to determine a location for the shutter glasses 100-104.

Other embodiments for position location could also be implemented, such as the use of a light source emitter on the cooperative location device 106 with the position indicator device 112 on the television 110 being used to determine the location of the glasses 100-104. This could involve the use of time-of-flight technology that tracks the time duration required for signals to reach various transmitters, or other known types of head tracking technologies. If the location determination is made at the television 110, this information can be transmitted back to the glasses 100-104 to ensure that the glasses 100-104 are properly synched to the correct program. Alternatively, this information could be used by the television 110 to change the manner in which the differing programs are transmitted by the television 110. Non-optical location techniques are also possible, such as radio frequency triangulation or other known techniques.

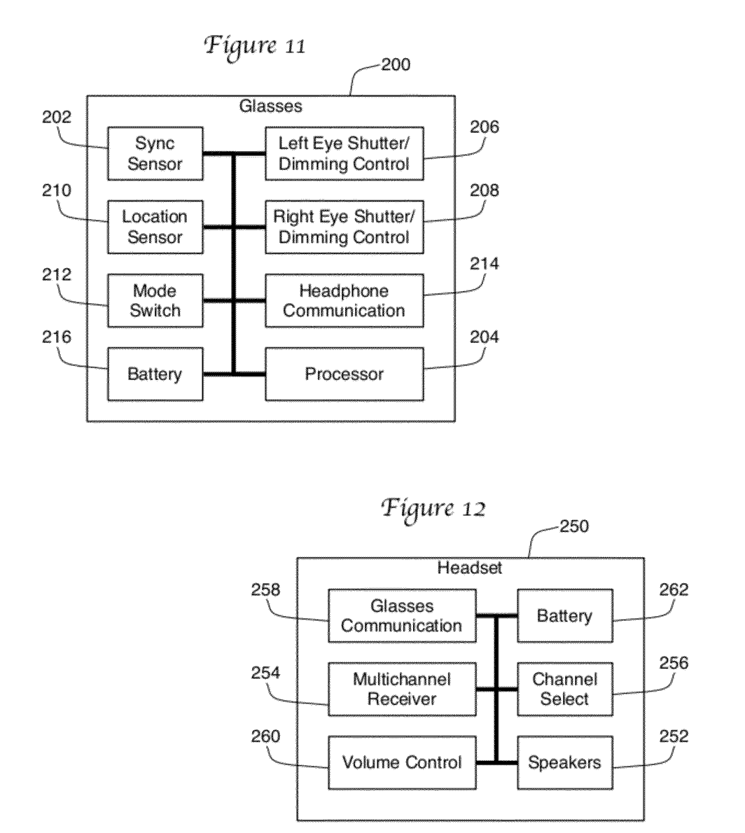

FIG. 11 is a schematic drawing of the electronics within a pair of shutter glasses 200 used in one embodiment of the invention. The pair of shutter glasses 200 receives a synchronization signal from the television through a sync sensor 202. The processor 204 uses the signal received from this sensor 202 to control the dimming or darkening of the left and right eyes via dimming or shutter controls 206, 208. The location sensor 210 and the mode switch 212 can be used by the processor 204 to control the operation of the dimming controls 206, 208, as explained above in connection with FIGS. 3a, 3b (mode switch) and FIG. 10 (location sensor). As explained above, the mode switch 212 allows the user to select which program currently being displayed on the television to be viewed through the glasses. The mode switch 212 need not be a physical switch, and can instead take the form of a memory device that records the currently channel or program that is to be viewed by the glasses 200. The memory contents can then be changed through a separate physical means, or even through a digital signal sent to the mode switch 212. Wireless or wired communication with the headphone or headset takes place through communication interface 214. Battery 216 provides power for the electronics in glasses 200.

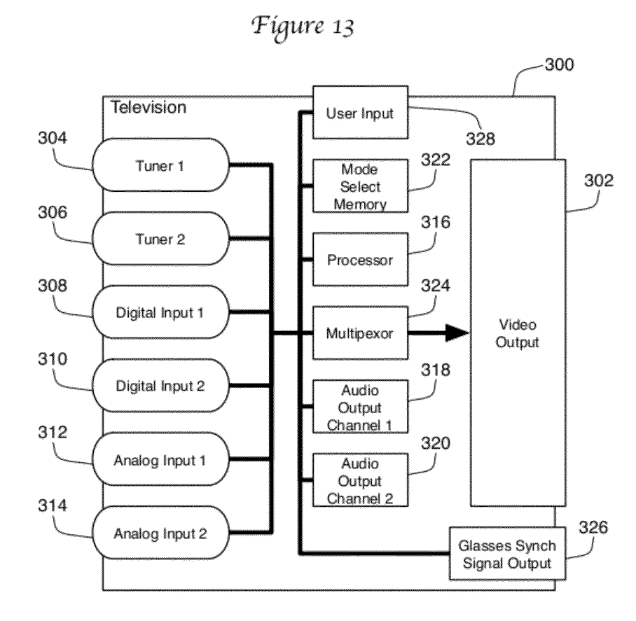

FIG. 12 is a schematic drawing of a headset 250 that could be used in connection with the glasses 200 of FIG. 11. The headset contains speakers 252 that provide sound to the user of the headset 250 and glasses 200 combination. In one embodiment, the headset 250 is capable of receiving a plurality of channels of wireless sound input from a television at multichannel receiver 254. The channel select feature 256 determines which sound channel is played over the speakers 252. In its simplest form, the channel select feature 256 could be a physical switch. In the preferred embodiment, the channel select 256 is a memory that can be updated via communications with the glasses 200 through glasses communication interface 258. This protocol device communicates with the headphone communications interface 214 of glasses 200, allowing the glasses 200 to automatically change the sound channel being played over the speakers 252 to correspond to the program being viewed through the glasses 200. The glasses 200 and headset 250 can communicate through a wired communication or through a wireless protocol such as the Bluetooth protocol. Alternatively, the glasses 200 and headset 250 could even be formed into a single, integrated unit.

In a preferred embodiment, the headset 250 contains an amplifier and a physical volume input device that form part of the volume control circuit 260. This circuit allows the user to change the volume of the sound being played over the speakers 252. A battery 262 powers the amplifier and the rest of the electronics in the headset 250.

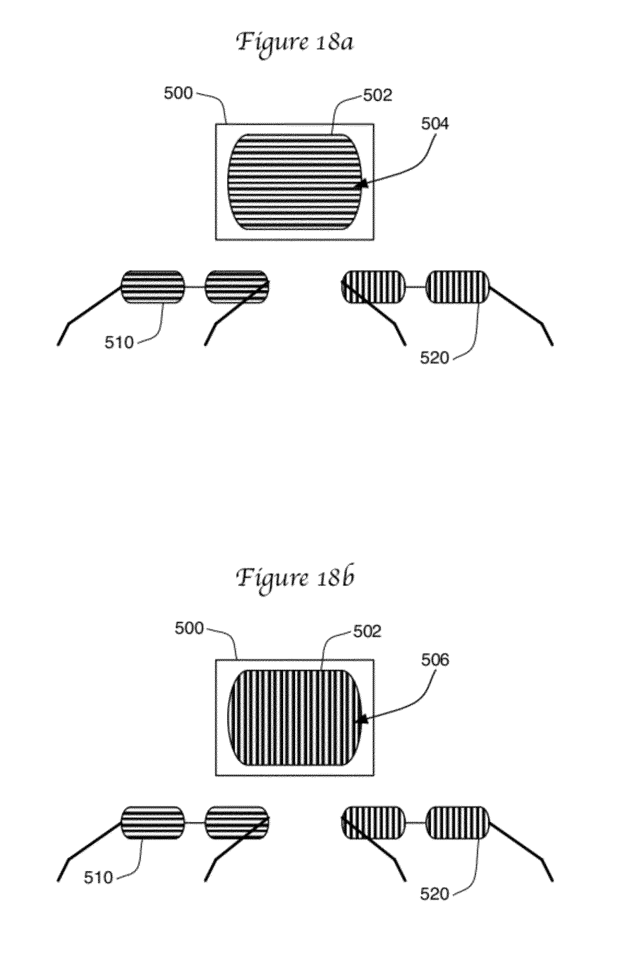

FIG. 13 shows a schematic illustration of one embodiment of a television 300 that utilizes some of the techniques of the present invention. The television 300 has a video output device 302 that provides the video programming to the user. The video output 302 may take the form of a CRT, LCD, or Plasma Display, or may be some type of projector. The primary requirement of the video output 302 is that it has a sufficient image display rate to display multiple programs in an alternate-image sequencing manner. Alternatively, the video output 302 should have the ability to show multiple images simultaneously using polarization, as described below in connection with FIG. 18. The television 300 receives the multiple programs from a plurality of inputs, including a plurality of tuners 304, 306, a plurality of digital inputs 308, 310, and a plurality of video inputs 312, 314. Each of these inputs can be used by a processor 316 to display a plurality of video programs simultaneously on the video output 302 and to output a plurality of related audio signals through separate audio output channels 318, 320. The processor 316 handles the high level functionality of the television 300, and may include one primary CPU or can contain a plurality of processing units specialized to handle particular functions within the television 300. For example, the Cell processor developed by the STI consortium can be used to handle various functions and image processing tasks within the television 300.

The determination as to which inputs 304-314 to combine are made by the processor 316 according to the current status of mode select memory 322. Memory 322 is preferably a tangible, persistent digital memory that stores configuration information for the television 300. This same memory 322 could be used to store algorithms used by the television 300 to implement the processes described herein.

One function of memory 322 is to track the current status of the television, effectively instructing the processor 316 of the type of presentation to present on the video output 302 and the sources 304-314 to use to present that image. For example, the video output 302 could present a single 2-D image, a single 3-D image, two simultaneous 2-D images, two simultaneous 3-D images, or even four simultaneous 2-D images. Obviously, with sufficient brightness and image rate in the video output 302, even more simultaneous programming may be possible using the same general techniques described herein. The selected ones of the multiple video inputs 304-314 are combined into an alternate-image sequencing display through a multiplexor circuit 324. Alternatively, a single input 304-314 may be capable of presenting two or more simultaneous programs to the television by itself. The multiplexor circuit applies time-division multiplexing in order to combine the selected inputs into the alternate-image sequencing display output. If the polarizing technique described in connection with FIG. 18 is used, the multiplexor circuit 324 combines the program in a manner compatible with that output. The synchronization signal for these multiple images is then transmitted by the television 300 to the glasses 200 through the glasses synch signal output 326.

Finally, a user's ability to change inputs is accepted through user input system 328, which might take the form of a receiver that receives optical (i.e., IR) or radio frequency instructions from a remote control. In the preferred embodiment, separate user input is provided for separate users based upon the program currently being viewed by the user. For example, a first user may use a remote to change the channel on tuner 304 so that the program being viewed by the first user may change while not changing the simultaneously viewed program of the second user. At a later time, the second user may wish to change the channel on their tuner (i.e., tuner 306) that would change their program without affecting the program of the first user. In this preferred embodiments, remote control signals received through user input 328 are understood to relate to one of the multiple programs currently being viewed. This can be accomplished through separate remote control devices for each user. Alternatively, a single remote can identify which user is currently using the remote based upon the shutter glasses being used by that user. This can be accomplished by a user's manual selection on the remote or by having the remote identify the physically closest pair of shutter glasses and by transmitting to the television 300 that identification information along with the command selected by the user on the remote.

Although FIG. 13 shows all of the components 302-328 existing within the same physical enclosure as the video output 302, it is well within the present invention to separate these components into separate enclosures. For instance, one embodiment of the present invention incorporates the ability to combine multiple programs into an external, home theater component 340 as shown in FIG. 14. Such a component could take the form of a home theater receiver that performs all of the traditional functions of such a component. In this embodiment, the receiver 340 would include all of the components 302-328 of the television 300 shown in FIG. 13 except for the video output 302. The receiver 340 would select the programs for multiplexing in multiplexor 324 from the available inputs 304-314. The combined signal would be output to an external television or monitor 301 for display on the video output 302 of that television 301 such as through an HDMI 1.4 connection. The audio outputs 318, 320, and the synch signal output 326 for the glasses would be output by the receiver 340. In this way, the television 301 could be a standard 3D television that receives and presents two separate image streams, with the intelligence necessary to multiplex and synchronize the separate programs occurring completely within the receiver 340 and the glasses 20. In another embodiment, the glasses 200 utilize the synch signals emanating from the television 301, with the glasses 200 having the intelligence to switch between the 3D mode of FIGS. 1 and 2 to the simultaneous programming mode of FIGS. 3 and 4.

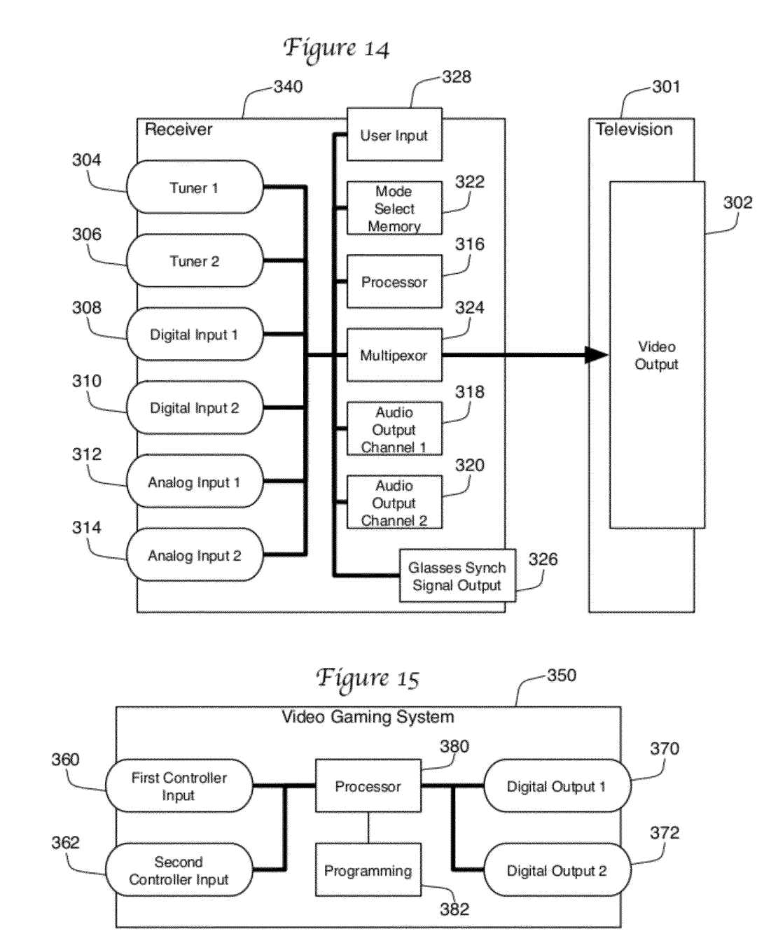

FIG. 15 shows a video gaming system 350 that can form part of yet another embodiment of the present invention. The video game system 350 takes advantage of the ability of television 300 to display two full screen images simultaneously to two different viewers. Prior art gaming systems allow multiple players of a single game to share a single screen through the use of split screens, where each player is presented their viewpoint into the game via a subsection (i.e., one-half or one-quarter) of the physical screen space. In contrast, video game system 350 allows multiple players to interact with the gaming system 350 through a plurality of gaming controller inputs 360, 362 and then outputs a separate, full screen output for each player. This is accomplished using a plurality of video outputs, such as digital video outputs 370-372. The full screen outputs 370-372 can then be fed into the video inputs of television 300, such as digital inputs 308, 310. In other embodiments, only a single output 370 and a single corresponding input 308 will be necessary to send both programs to the television. For instance, HDMI connections using the HDMI 1.4 standard can transmit two video signals simultaneously on a single connection. In this way, both full screen viewpoints can then be presented simultaneously to the players through video output 302 as described above. To create the full screen outputs for digital outputs 370-372, the gaming system 350 uses a processor 380 to apply the user inputs received from 360-362 to the programming 382 that defines the game and its rules. The programming 382 is preferably stored on tangible, persistent memory such as an optical disk, flash memory, or a physical hard drive (not shown). The programming can be stored within the physical confines of the gaming system 350, or can be accessed from physical memory that is accessible to the gaming system 350 over a wired or wireless network, including a local Wi-Fi LAN or a WAN such as the Internet. The processor can be a general purpose processor such as a core i5 or core i7 CPU from Intel, or a more specialized processor such as a Cell microprocessor designed by the STI alliance and used by Sony in its PlayStation 3 game console.

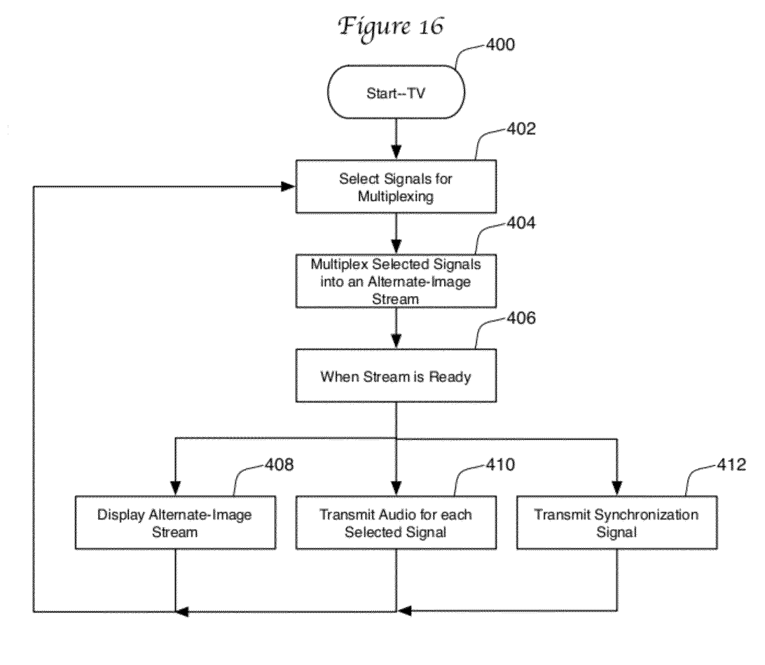

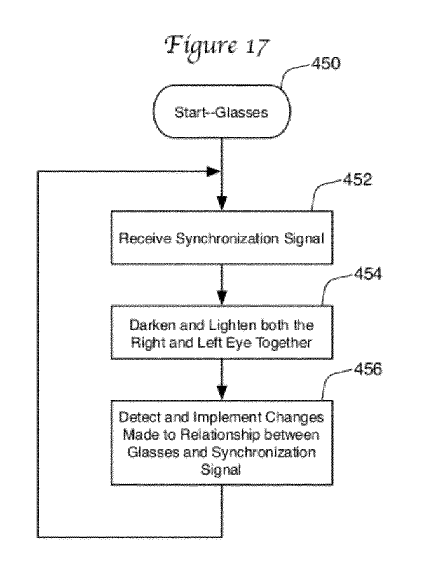

The method used by one embodiment of the present inventions is shown in the flow charts of FIGS. 16 and 17. In FIG. 16, a method for operating a television starts at step 400. At step 402, the television must select the signals desired to be multiplexed. As explained above, the signals may be two or more 2-D or 3-D programs. The selected programs are then multiplexed in a time-division manner into a single alternate-image stream in step 404. Once this video stream is ready at step 406, the stream is presented to the video output in step 408. At the same time the stream is displayed in step 408, the television also transmits an audio signal for each of the program signals in step 410, and also transmits a synchronization signal in step 412. The synchronization signal and the audio signals are synchronized with the display of the alternate-image stream of step 408. The process can continue indefinitely as the different video streams are again multiplexed together at step 404. The method of FIG. 16 shows the loop returning to step 402, because at any time while watching the video streams one of the users may elect to change the program that they are watching (i.e., by changing channels or inputs through a remote control). Note that a change of programming by one user does not need to alter the programming viewed by the other users. In addition, each user is free to select programming from different inputs, or to change inputs after they begin to view their elected programming. After changing the programming selected for multiplexing in step 402, the method again multiplexes the signals in step 404 and presents the video stream, audio signals, and synch signals in step 408, 410, and 412, respectively.

In process 450 shown in FIG. 17, it is seen that the shutter glasses first receive the synchronization signal from the televisions in step 452, and then darken and lighten the left and right glass together in accordance with the synchronization signal in step 454. The synchronization signal may be received through a radio frequency receiver or optical receiver. One benefit of an optical receiver is that the glasses can be configured to have a default transparent condition if the optical signal is not received, thereby causing the glasses to become transparent if the television is powered off or if the user looks away from the television. While a radio frequency signal can work similarly when the television is powered off, such a signal cannot be easily used to determine if a user has looked away from the television. As explained above, it is possible that the glasses can alter they way in which they respond to the synchronization signal. In a first state, for instance, the glasses may darken and light the glass in order to view a first program on the television, while in a second state the glasses may allowing viewing of a second program. In step 456, the glasses detect changes in this state and, if necessary, alter their functioning with respect to the synchronization signal before receiving the signal again in step 452.

FIGS. 18a and 18b show another embodiment of a television 500 that implements the present invention using passive 3D technology. In this case, television 500 is able to simultaneously display two programs without interleaving the programs over time. Instead, both programs are displayed at once by dividing the physical area of the screen between the two programs. If the screen 502 of the television 500 is considered to be divided into pixels, half of the pixels will show a first program 504 (as shown in FIG. 18a), while the other half of the pixels show a second program 506 (shown in FIG. 18b). In most embodiments, this is accomplished by dividing the pixels into interlaced, horizontal rows, with the even rows showing the first program 504 and the odd numbered rows showing the second program 506. The two groups of pixels are separated by using a different polarization for each group. The pixels that show the first program 504 are polarized in a first direction (shown as horizontal in FIG. 18a), while the pixels that show the second program 506 are polarized in a second direction (the vertical direction in FIG. 18b). Users are able to see only one of the programs by using glasses 510, 520 that are polarized to see one of the programs 504, 506. For instance, glasses 510 are shown in FIG. 18 as polarized in the horizontal direction. As a result, the wearer of glasses 510 can see program 504. Program 506, which is polarized in the vertical direction, will not be seen by the wearer of glasses 510 because the polarization on each of the lenses in glasses 510 will block that program. Similarly, the vertical polarization of both lenses in glasses 520 will allow the second program 506 to be seen by the wearer of these glasses 520, but will block the first program 504. Of course, the vertical and horizontal polarization shown in FIG. 18 is merely exemplary, as a more standard arrangement for polarization televisions is at 45 and 135 degrees.

As with standard 3D televisions, polarization televisions such as television 500 lose picture quality when showing multiple programs 504, 506. Television 10 lost refresh rate when time-division multiplexing two programs together, since each program received only half of the television's possible refreshes. Television 300 suffers a loss of resolution as each program receives only half of the television's resolution. Since half the screen area (i.e., half of the pixels) will be used to present one of the two programs 504, 506, the effective resolution of the television 500 is halved. Thus, a television set 500 with 1080 lines of horizontal resolution will utilize only 540 lines per program 504, 506 when using passive, polarization-based glasses 504, 506. A television that could produce 2160 lines of resolution could devote 1080 lines per program 504, 506, and thus present both programs at 1080i or 1080p high definition resolution.

It is possible to present more than two programs 504, 506 on the television at a time. All that is necessary is for the television 500 to divide the screen area into three or more programs, and applying a separate polarization for each program. For example, the top row of resolution in television 500 could be dedicated to a first program, the second row to a second program, the third row to a third program and the fourth row to a fourth program. The fifth row would return to the first program, followed by the second program, and so on. The rows of resolution dedicated to the first program would receive a first polarization angle (such as 0° or horizontal), the second program would receive a second polarization angle)(45°, the third program a third polarization angle)(90°, and the fourth program a fourth angle)(135°. Glasses adjusted for each of these polarizations would be provided, so that four different viewers would see four different programs being simultaneously displayed on the same television 500. As described above, this would allow four completely different programs to be displayed to users, provided each user was able to receive their own, separate audio track. Alternatively, this would allow four users to see four different views of the same program, such as in a video gaming system, which would require only a single soundtrack.

Because the polarization of the individual glasses does not change, each set of glasses 510, 520 will be permanently assigned to separate channels on the television 500. The delivery of audio programming is therefore simplified, as glasses 510 can be permanently assigned to the first audio track and glasses 520 can be assigned to the second audio track. Users need only select the headphones that match the glasses 510, 520 to ensure that the audio and video signals will coincide. Alternatively, the methods described above for matching audio and video signals could be implemented on the system shown in FIG. 18.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A television comprising:
a) at least one program input receiving a first and second program signal, each program signal having an audio and a video component;
b) a display device that presents a video output to a user that alternates between the video components of the first and second program signals;
c) a synch signal transmitter that transmits a synchronization signal synched to the alternation between the first and second program signal on the video output; and
d) an audio signal output that transmits both a first audio signal containing the audio component of the first program signal, and a second audio signal containing the audio component of the second program signal.

2. The television of claim 1, wherein the display device comprises a video screen selected from a set including a cathode ray tube, an LCD panel, and a plasma panel.

3. The television of claim 1, wherein none of the program inputs are video tuners.

4. The television of claim 1, wherein the audio signal output is a wireless audio transmitter that transmits the first and second audio signal on separate wireless channels.

5. The television of claim 1, further comprising:
e) a first and second pair of shutter glasses each having a left and a right eye-glass, wherein
i) the first pair of shutter glasses has a first state that responds to the synchronization signal by lightening its right and left eye glass to allow viewing of the first program signal and darkening its left and right eye glass to prevent viewing of the second program signal, and
ii) the second pair of shutter glasses responding to the synchronization signal by lightening its right and left eye glass to allow viewing of the second program signal and darkening its left and right eye glass to prevent viewing of the first program signal.

6. The television of claim 5, wherein the first pair of shutter glasses has a second state that responds to the synchronization signal by lightening its right and left eye glass to allowing viewing of the second program signal and darkening its left and right eye glass to prevent viewing of the first program signal.

7. The television of claim 6, wherein the first pair of shutter glasses can be manually switched from the first state to the second state.

8. The television of claim 6, wherein the first pair of shutter glasses is responsive to a position location sensor, wherein the first pair of shutter glasses changes from the first state to the second state when the position location sensor detects a change in location of the first pair of shutter glasses with respect to the display device.

9. The television of claim 8, wherein the position location sensor resides on the first pair of shutter glasses.

10. The television of claim 9, wherein the position location sensor responds to an infrared signal emitted from a location on the television proximal to the video output.

11. The television of claim 8, wherein the position location sensor resides proximal to the display device.

12. The television of claim 8, wherein the first pair of shutter glasses changes from the first state to the second state when the location of the shutter glasses passes a normal line extending outward from the video output.

13. The television of claim 5, wherein the right and left eye glass of each of the shutter glasses lighten and darken at the same time.

14. The television of claim 5, wherein the video component of the first program signal is 3-D, and the right and left eye glass of the first pair of shutter glasses lighten and darken sequentially.

15. The television of claim 5, further comprising:
f) a first audio headset having speakers that, when the first pair of shutter glasses are in the first state, receives and plays over the speakers the first audio signal.

16. The television of claim 6, further comprising:
f) a first audio headset having speakers that, when the first pair of shutter glasses are in the first state, receives and plays over the speakers the first audio signal, and when the first pair of shutter glasses are in the second state, receives and plays over the speakers the second audio signal.

17. The television of claim 16, wherein the first pair of shutter glasses communicates the state of the first pair of shutter glasses to the first audio headset via a wireless communications path.

18. The television of claim 17, wherein the first pair of shutter glasses and the first audio headset each includes Bluetooth circuitry, wherein the wireless communications path is a Bluetooth connection.

19. The television of claim 5, wherein the shutter glasses are liquid crystal shutter glasses.

20. A system for watching a plurality of program signals simultaneously comprising:
a) a television comprising
i) a video output that alternates between a first-signal frame from a first program signal and a second-signal frame from a second program signal, and
ii) a synch synchronization transmitter that transmits a synchronization signal synched to the changes in the video output between the two program signals,
b) a first and second pair of shutter glasses, each pair of shutter glasses having:
i) a synchronization signal receiver that receives the synchronization signal from the television, and
ii) two darkening lenses that darken and lighten in response to the synchronization signal to view only one of the first and second program signals on the video output, wherein the first and second pair of shutter glasses use the same synchronization signal to view different program signals on the video output.

21. The system of claim 20, wherein the television further includes an audio transmitter that transmits a first and second audio signal corresponding to the first and second program signal, respectively, and wherein the shutter glasses each maintains a state variable indicating a choice between the first and second program signals, and further comprising:
c) a first and second pair of wireless headsets each having:
i) a data communication path to the first and second pair of shutter glasses, respectively, the data communication path receiving a value of the state variable from the pair of shutter glasses, and
ii) an audio receiver that receives and plays one of the first and second audio signals based on the value of the state variable.

22. The system of claim 20, wherein
i) the television further includes an audio transmitter that transmits a first and second audio signal corresponding to the first and second program signal, respectively, and
ii) the first pair of shutter glasses decodes the first audio signal and the second pair of shutter glasses decodes the second audio signal

23. The system of claim 22, further comprising a first and second headset, wherein the first headset receives the decoded first audio signal from the first pair of shutter glasses and outputs the first audio signal through a first pair of speakers, and further wherein the second headset receives the decoded second audio signal from the second pair of shutter glasses and outputs the second audio signal through a second pair of speakers.

24. The system of claim 23, wherein the first and second headset both connect to the first and second pair of shutter glasses, respectively, through an audio plug on the shutter glasses.

25. A system for watching a plurality of program signals simultaneously comprising:
a) a multiplexor that combines a first program and a second program into a single video stream including both programs;
b) a video output that simultaneous displays the first and second program over a single video output;
c) a first set of viewing glasses having two lenses that both allow the first program received from the video output to pass through the lenses and that both block the second program received from the video output from passing through the lenses;
d) a second set of viewing glasses having two lenses that both allow the second program received from the video output to pass through the lenses and that both block the first program received from the video output from passing through the lenses.

26. The system of claim 25, further comprising
e) programming selection input allowing the first program to change without altering the second program.

27. A method of operating a home theater receiver comprising:
a) receiving a first selection from a first user of a first program,
b) receiving a second selection from a second user of a second program;
c) receiving the first and second program from at least one video input into the receiver;
d) multiplexing the first and second program streams into a first combined video stream using alternate frame sequencing;
e) outputting the first combined video stream to a television for display;
f) watching the first program on the television using a first set of shutter glasses and the second program on the television using a second set of shutter glasses.

28. The method of claim 27, further comprising:
g) receiving a third selection from the first user of a third program;
h) receiving the third program from the at least one video input into the receiver
i) multiplexing the third and second program streams into the second combined video stream;
j) outputting the second combined video stream to a television for display;
k) watching the third program on the television using the first set of shutter glasses and the second program on the television using the second set of shutter glasses

29. The method of claim 28, wherein the third and second programs are received on different video inputs into the receiver.

30. The method of claim 29, wherein the first and third programs are received on different video inputs into the receiver.

31. The method of claim 27, further comprising transmitting a synch signal from the home receiver to the first and second set of shutter glasses.

32. A method for presenting multiple full screen images simultaneously on a television to a first and second pair of shutter glasses comprising:
a) selecting a first and second television signal for combination;
b) alternating consecutive frames of the first and second television signal through a video output by
i) outputting a first frame of the first television signal through the video output;
ii) outputting a first frame of the second television signal through the video output;
iii) sending a synchronization signal to the first and second pair of shutter glasses that instructs the first pair of shutter glasses to view the first television signal and not the second television signal and that instructs the second pair of shutter glasses to view the second television signal and not the first television signal
c) repeating the alternating step b) through a plurality of frames of the first and second television signal.

33. The method of claim 32, further comprising:
d) transmitting a first audio signal corresponding to the first television signal on a first wireless audio channel while simultaneous transmitting a second audio signal corresponding to the second television signal on a second wireless audio channel.

34. The method of claim 32, wherein the alternating step includes outputting a first frame of a third television signal through the video output after outputting the first frame of the second television signal, and further wherein the synchronization signal instructs a third pair of shutter glasses to view the third television signal and not the first and second television signals.

35. The method of claim 32, further comprising:
d) receiving a first signal from a remote control, the first signal indicating both a first user-desired change and an indicator that the first television signal should be changed; and
e) altering the first television signal to reflect the first user-desired change received from the remote control while not altering the second television signal.

36. The method of claim 35, further comprising:
f) receiving a second signal from the remote control, the second signal indicating both a second user-desired change and an indicator that the second television signal should be changed; and
g) altering the second television signal to reflect the second user-desired change received from the remote control while not altering the first television signal.

37. The method of claim 36, wherein the remote determines whether to change the first or second television signal by detecting which pair of shutter glasses are closest to the remote.

38. A gaming system comprising:
a) a gaming processor that accepts inputs from two different users and applies programming and the inputs to create two different, full-frame program signals, one for each of the different users;
b) a television comprising
i) a video output that alternates between a first-signal frame from the first program signal and a second-signal frame from the second program signal, and
ii) a timing synchronization transmitter that transmits a synchronization signal timed with the changes between the program signals in the video output,
c) a first and second pair of shutter glasses, each pair of shutter glasses having:
i) a synchronization signal receiver that receives the synchronization signal from the television, and
ii) two darkening lenses that darken and lighten in response to the synchronization signal to view only one of the first and second program signals.
